(19) United States
(12) Patent Application Publication
(10) Pub. No.: US 2009/0130764 A1
(43) Pub. Date: May 21, 2009

(54) METHODS OF TREATING METAL CONTAINING HAZARDOUS WASTE USING CORN ASH CONTAINING ORTHOPHOSPHATES

(76) Inventor: Robert Stanforth, Madison, WI (US)

Correspondence Address: QUARLES & BRADY LLP, 33 E. MAIN ST, SUITE 900, P.O BOX 2113, MADISON, WI, 53701-2113, US

(21) Appl. No.: 12/273,798

(22) Filed: Nov. 19, 2008

Related U.S. Application Data
(60) Provisional application No. 60/988,979, filed on Nov. 19, 2007.

(51) Int. Cl. A62D 3/33; G01N 31/00

(52) U.S. Cl. 436/2; 588/315

(57) ABSTRACT

A method of treating a waste material or soil by contacting the waste material or soil with an effective amount of corn ash to lower metal leaching in a Toxicity Characteristics Leaching Procedure test to below the hazardous waste characteristic criteria producing a treated waste material or soil, wherein the corn ash contains an effective amount of one or more orthophsophates. Preferably, the corn ash is substantially free of polyphosphates. The waste material or soil is a hazardous waste containing one or more metals being Cd, Pb and Zn. The waste material is generated by a foundry or steel mill.

### CROSS REFERENCE TO RELATED APPLICATIONS

The application claims priority to and the benefit of U.S. Provisional Application Ser. No. 60/988,979 filed on Nov. 19, 2007, which is also incorporated herein by reference in its entirety.

### STATEMENT REGARDING FEDERALLY SPONSORED RESEARCH OR DEVELOPMENT

Not applicable.

### BACKGROUND OF THE INVENTION

Some foundry wastes (such as wastes generated at iron foundries) and metal-contaminated soils are classified as hazardous due to the leached concentrations of cadmium (Cd) and/or lead (Pb). Such classification is in accordance with the U.S. Environmental Protection Agency's (USEPA) Toxicity Characteristics Leaching Procedure (TCLP, SW846 Method 1311) test for classifying waste as hazardous. Various approaches have been developed to treat such hazardous wastes in order to render them nonhazardous.

In one approach as taught in U.S. Pat. No. 5,037,479, orthophosphates and pH control agents have been used to treat Cd and Pb containing hazardous waste. Specifically, Triple Super Phosphate (TSP) has been used as the phosphate source, and ordinary magnesium oxide (MgO) has been used to control pH. That combination has been an effective treatment methodology for many years. One reason for its success over approaches using more alkaline pH control agents is that MgO is an effective buffer that prevents the pH for rising to the point where Pb solubilizes as an anionic complex.

### BRIEF SUMMARY OF THE INVENTION

One aspect of the invention is a method of treating a waste material or soil comprising the steps or acts of contacting the waste material or soil with an effective amount of corn ash to lower metal leaching in a Toxicity Characteristics Leaching Procedure test to below the hazardous waste characteristic criteria producing a treated waste material or soil, wherein the corn ash contains an effective amount of one or more orthophsophates, which is characterized as having a PO₄³⁻ ion. The orthophosphates include HPO₄²⁻, H₂PO₄¹⁻ and H₃PO₄. As used herein, an “effective amount” means an amount to lower metal leaching in a Toxicity Characteristics Leaching Procedure test to below the hazardous waste characteristic criteria.

In an exemplary embodiment of the method of treating the waste material or soil, the corn ash is substantially free of polyphosphates.

In another exemplary embodiment of the method of treating the waste material or soil, the waste material or soil is a hazardous waste containing one or more metals selected from the group consisting of Cd, Pb and Zn.

In another exemplary embodiment of the method of treating the waste material, the waste material is generated by a foundry or steel mill.

In another exemplary embodiment of the method of treating the hazardous waste material, the hazardous waste leaches 121-141 mg/L Pb in a TCLP test. [00010] In another exemplary embodiment of the method of treating the hazardous waste material, the hazardous waste leaches 3.71-4.32 mg/L Cd, 8.90-13.1 mg/L Pb and 1020-1320 mg/L Zn in a TCPL test.

In another exemplary embodiment of the method of treating the waste material or soil, the method further comprises contacting the waste material or soil with an effective amount of mined magnesium oxide or magnesium hydroxide.

In another exemplary embodiment of the method of treating the waste material or soil, the method further comprises contacting the waste material or soil with an effective amount of triple super phosphate.

In another exemplary embodiment of the method of treating the waste material or soil, the effective amount of corn ash is in the range of 0.5 wt % to 6 wt %.

In another exemplary embodiment of the method of treating the waste material or soil, the effective amount of corn ash is in the range of 4 wt % to 6 wt %.

In another exemplary embodiment of the method of treating the waste material or soil, the Pb concentration in a TCLP test leachate from the treated hazardous waste is less than 5.0 mg/L.

In another exemplary embodiment of the method of treating the waste material or soil, the effective amount of corn ash is in the range of 0.5 wt % to 5 wt %.

In another exemplary embodiment of the method of treating the waste material or soil, the effective amount of corn ash is in the range of 1 wt % to 5 wt %.

In another exemplary embodiment of the method of treating the waste material, the hazardous waste is treated by injecting corn ash into ducts within the foundry or steel mill.

In another exemplary embodiment of the method of treating the waste material, the steel mill or foundry has an in-line treatment system, and the corn ash is administered by the in-line treatment system.

In another exemplary embodiment of the method of treating waste material or soil, the hazardous waste is derived from a lead paint abatement project and or utility manhole sediments.

In another exemplary embodiment of the method of treating waste material or soil, the soil is contaminated with sufficient lead that it would need to be treated as hazardous if excavated and disposed.

### BRIEF DESCRIPTION OF THE DRAWINGS

FIG. 1 is graph showing dose response curves for treating an iron foundry waste using corn ash compared to TSP, TSP/Corn Ash and MgO/TSP treatments, whereby the effect of corn ash treatment on TCLP Pb is demonstrated.

FIG. 2 is a graph showing dose response curves for treating a brass foundry waste using corn ash compared to TSP, whereby the effect of corn ash on TCLP Pb is demonstrated.

### DETAILED DESCRIPTION OF THE EXEMPLARY EMBODIMENTS

There are several waste ash streams from the generation of ethanol from corn material. Some of these ashes contain high phosphorus contents. In some cases, up to 80% of the ash material is phosphorus. One use of this material would be as a source of phosphate during lead treatment.

Lead reacts with phosphate to form a number of highly insoluble compounds, including the pyromorphites like Pb₅(PO₄)₃OH or Pb₅(PO₄)₃Cl. These compounds have a sufficiently low leaching potential to minimize lead leaching in the pH range common in the natural environment or in regulatory leaching tests. Due to this low leaching potential, phosphate can be used to stabilize lead in hazardous waste and render the waste nonhazardous or less hazardous. The form of phosphate is important. Orthophosphates, which have a PO₄³⁻ ion, form insoluble compounds with lead. Polyphosphates complex lead bringing it into solution.

A sample of ash from an ethanol generating plant was used in the testing. The ash was used as a treatment additive with two hazardous wastes, with the measurement of treatment effectiveness being a reduction in lead leaching in a TCLP test. TSP (triple super phosphate), and TSP mixed with magnesium oxide were tested for comparison. One of the wastes came from an iron foundry and contained a high concentration of zinc. The other waste was from a brass foundry, which has a high leachable lead concentration.

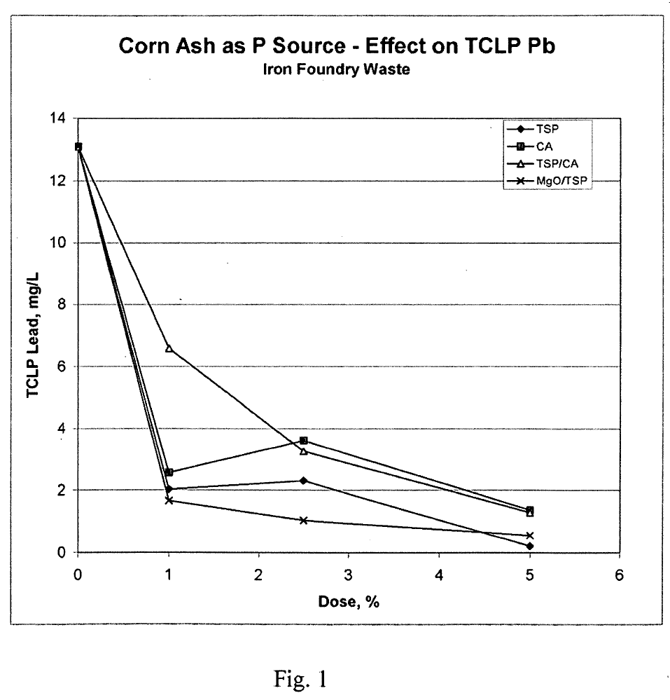

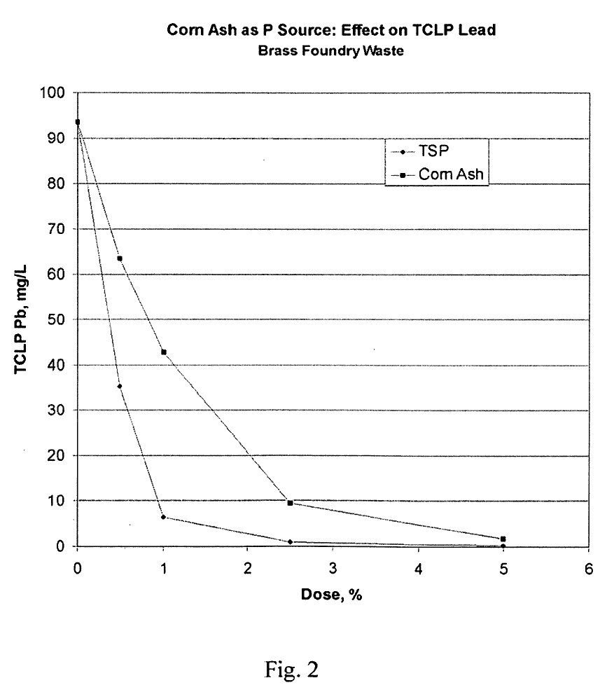

The results of the screening tests are shown in FIGS. 1 and 2. The corn ash sufficiently reduced lead leaching in a TCLP test for both wastes such that the wastes were no longer hazardous for lead (Tables 1 and 2). Cadmium and zinc leaching for the brass foundry waste were also significantly reduced.

Corn ash effectively lowered the lead concentration in a TCLP test. Because the corn ash lowered lead concentrations in the TCLP test, the phosphate in the waste was substantially or entirely orthophosphates rather than polyphosphates. Thus, corn ash is a low cost and effective phosphate source for treating lead in hazardous waste, particularly hazardous waste generated at foundries and steel mills.

Corn ash is neutral in pH, whereas TSP is acidic. The neutral pH character of corn ash is advantageous because the need for adding MgO to neutralize the acid associated with TSP would be significantly reduced or eliminated altogether. A blend that contains 20% MgO and 80% TSP is commonly used for lead remediations. The MgO neutralizes the acid in the TSP, which prevents the pH from becoming more acidic. The solubility of lead is sensitive to pH. Therefore, maintaining a neutral pH helps to reduce lead mobility in the environment and helps to lower additive dosage and overall treatment costs.

Applications for the instant corn ash technology include remediation of lead-contaminated soil or waste. Corn ash can be used as a phosphate source for lead remediation projects. Other applications include in-line treatment of process wastes. Corn ash can be used as a substitute for TSP in fixed-base (in-line) heavy metal treatment applications. Since corn ash is generated as a fine powder, the grinding step (which is typically required to process TSP) is eliminated.

Another application includes lead paint abatement and manhole sediments. Corn ash can be used in conjunction with EnviroPrep® for lead paint abatement projects and treatment of utility manhole sediments.

### EXAMPLES

### Example 1

### Treatability Test Results on Lead Contaminated Soil

TABLE 1
Compositional Analysis

| Sample | Pb, mg/kg |
|---|---|
| Soil | 16,000 |

| | |
|---|---|
| Sample | Pb, mg/L |

Screening TCLP Test Results

| | |
|---|---|
| Untreated (A) | 121 |
| Untreated (B) | 141 |

Corn Ash

| | |
|---|---|
| 2% Corn Ash | 7.70 |
| 2.5% Corn Ash | 6.62 |
| 4% Corn Ash (a) | 0.12 |
| 4% Corn Ash (b) | 0.25 |

### Example 2

Screening test results using corn ash as a phosphate source are shown below in Table 2.

TABLE 2

| | | | |
|---|---|---|---|
| Dose, | Cd | Pb | Zn |

| | | | |
|---|---|---|---|
| Additive | % | pH | mg/L |

Screening TCLP Results

Waste 1 (Iron Foundry Baghouse Dust)

| | | | | | |
|---|---|---|---|---|---|
| Hazardous Waste Criteria | | — | 1.0 | 5.0 | — |
| Untreated (Waste 1) | A | 5.24 | 4.32 | 13.1 | 1020 |
| | B | — | 3.71 | 8.90 | 1320 |
| TSP | 1 | 5.28 | 3.84 | 2.03 | 980 |
| | 2.5 | 5.24 | 3.95 | 2.31 | 1150 |
| | 5 | 4.99 | 3.55 | 0.215 | 1070 |
| Corn Ash | 1 | 5.31 | 3.39 | 2.57 | 1370 |
| | 2.5 | 5.39 | 3.49 | 3.61 | 1300 |
| | 5 | 5.62 | 3.07 | 1.37 | 1450 |
| 50/50 Corn Ash/TSP | 1 | 5.29 | 4.20 | 6.59 | 1810 |
| | 2.5 | 5.25 | 3.64 | 3.26 | 1500 |
| | 5 | 5.25 | 3.49 | 1.29 | 1540 |
| 50/50 MgO/TSP | 1 | 5.47 | 3.29 | 1.67 | 1590 |
| | 2.5 | 5.81 | 2.72 | 1.04 | 1540 |
| | 5 | 6.32 | 3.10 | 0.56 | 1540 |

Waste 2 (Brass Foundry Waste)

| Untreated | | 4.57 | 0.49 | 93.7 | 386 |
|---|---|---|---|---|---|
| TSP | 0.5 | 4.54 | 0.51 | 35.4 | 480 |
| | 1 | 4.40 | 0.49 | 6.30 | 526 |
| | 2.5 | 4.25 | 0.38 | 0.87 | 514 |
| | 5 | 4.22 | 0.31 | 0.27 | 526 |
| Corn Ash | 0.5 | 4.54 | 0.51 | 63.4 | 456 |
| | 1.0 | 4.58 | 0.52 | 42.7 | 364 |
| | 2.5 (a) | 4.49 | 0.48 | 9.30 | 416 |
| | 2.5 (b) | 4.47 | 0.50 | 9.41 | 462 |
| | 5.0 | 4.50 | 0.34 | 1.68 | 260 |
| | | Screening Water Leach Test | | | |
| Corn Ash | 5 | 10.96 | 0.00062 | 0.0067 | 0.270 |

We claim:

1. A method of treating a waste material or soil comprising contacting the waste material or soil with an effective amount of corn ash to lower metal leaching in a Toxicity Characteristics Leaching Procedure test to below the hazardous waste characteristic criteria producing a treated waste material or soil, wherein the corn ash contains an effective amount of one or more orthophsophates.

2. The method of claim 1, wherein the corn ash is substantially free of polyphosphates.

3. The method of claim 1, wherein the waste material or soil is a hazardous waste containing one or more metals selected from the group consisting of Cd, Pb and Zn.

4. The method of claim 3, wherein the waste material is generated by a foundry or steel mill.

5. The method of claim 4, wherein the hazardous waste leaches 121-141 mg/L Pb in the Toxicity Characteristics Leaching Procedure test.

6. The method of claim 4, wherein the hazardous waste leaches 3.71-4.32 mg/L Cd, 8.90-13.1 mg/L Pb and 1020-1320 mg/L Zn in the Toxicity Characteristics Leaching Procedure test.

7. The method of claim 4, further comprising contacting the waste material with an effective amount of mined magnesium oxide or magnesium hydroxide.

8. The method of claims 4 or 7, further comprising contacting the waste material with an effective amount of triple super phosphate.

9. The method of claim 5, wherein the effective amount of corn ash is in the range of 0.5 wt % to 6 wt %.

10. The method of claim 5, wherein the effective amount of corn ash is in the range of 4 wt % to 6 wt %.

11. The method of claim 10, further comprising conducting a Toxicity Characteristic Leaching Procedure on the treated waste material or soil producing a to lower metal leaching in a Toxicity Characteristics Leaching Procedure test to below the hazardous waste characteristic criteria-tested waste material or soil, and, determining metal concentrations in leachates from the to lower metal leaching in a Toxicity Characteristics Leaching Procedure test to below the hazardous waste characteristic criteria-tested waste material or soil, wherein the metal concentrations in leachates are less than the hazardous waste criteria for such metals.

12. The method of claim 6, wherein the effective amount of corn ash is in the range of 0.5 wt % to 5 wt %.

13. The method of claim 6, wherein the effective amount of corn ash is in the range of 1 wt % to 5 wt %.

14. The method of claim 13, wherein the Pb concentration in a to lower metal leaching in a Toxicity Characteristics Leaching Procedure test to below the hazardous waste characteristic criteria test leachate from the treated hazardous waste is less than 5.0 mg/L.

15. The method of claim 1, wherein the waste material is treated by injecting corn ash into ducts within the foundry or steel mill.

16. The method of claim 4, wherein the steel mill or foundry has an in-line treatment system, and wherein the corn ash is administered by the in-line treatment system.

17. The method of claim 1, wherein the waste material is derived from a lead paint abatement project and or utility manhole sediments.

18. The method of claim 1, wherein the soil is contaminated with sufficient lead that it would need to be treated as hazardous if excavated and disposed.
